(19) United States
(12) Patent Application Publication
(10) Pub. No.: US 2005/0092393 A1
(43) Pub. Date: May 5, 2005

(54) Wood waste removing device for a planer

(76) Inventor: Haw-Hui Chu, Taichung City (TW)

Correspondence Address: TROXELL LAW OFFICE PLLC, SUITE 1404, 5205 LEESBURG PIKE, FALLS CHURCH, VA, 22041, US

(21) Appl. No.: 10/697,153

(22) Filed: Oct. 31, 2003

(51) Int. Cl. B27C 1/00; B27G 19/00; B27G 21/00

(52) U.S. Cl. 144/252.1; 144/117.1

(57) ABSTRACT

A wood waste-removing device for a planer includes a planing table, a wind exhausting shade, a blower and a transmitting cable. The planing table is installed thereon with a knife shaft driven to rotate by a motor. The wind exhausting shade is assembled above the knife shade. The blower is assembled on the wind exhausting shade, having a set of wheel-shaped blades and a rotary shaft. The rotary shaft is connected with one end of the knife shaft by a transmitting cable, able to actuate the blade to rotate. The knife shaft is driven by the motor to rotate and actuate the blower to operate by means of the transmitting cable, letting the knife shaft and the blower synchronously driven to operate by the same motor, simplifying the structure, saving cost needed for an additional motor and having an excellent function of removing wood waste.

### BACKGROUND OF THE INVENTION

1. Field of the Invention

This invention relates to a wood waste-removing device for a planer, particularly to one having a knife shaft and a blower synchronously started or stopped in operating by a same motor, simplifying the structure and economizing cost needed in assembling an additional motor.

2. Description of the Prior Art

In a planing process, a conventional planer always produces a great deal of wood waste floating about or dropping on the ground to soil a workshop and affect workers' health, and in this condition, large-sized vacuum cleaners have to be employed for removing the wood waste, not only taking much time and labor but also increasing cost in equipment. In view of this condition, the inventor of this invention previously devised a motor blower having functions of wood waste absorption and driving, which he applied for a US patent with the application Ser. No. 10/126655. The motor blower is additionally installed on a planing table of a planer to remove out wood waste produced in a planing process and then have it collected to keep a workshop clean.

However, although the motor blower is able to remove wood waste, yet it will increase cost in purchasing and assembling such an additional motor blower on the planing table of a planer, which originally has a motor provided thereon for driving a knife shaft to operate, and also it will consume much electricity if two motors operate together at the same time, not conforming to economic gain.

### SUMMARY OF THE INVENTION

One objective of the invention is to offer a wood waste-removing device for a planer, having a blower installed on the planing table of a planer and a transmitting cable connecting the blower and a knife shaft. Thus, the knife shaft and the blower can be synchronously driven by the same motor to operate or stop to enable the blower to suck and remove wood waste when the knife shaft performs planing of a wood material.

Another objective of the invention is to offer a wood waste removing device for a planer, having a blower and a knife shaft synchronously driven to operate by the same motor, needless to install an additional motor and able to lower cost and simplify the structure.

### BRIEF DESCRIPTION OF DRAWINGS

This invention will be better understood by referring to the accompanying drawings, wherein:

FIG. 1 is a front and perspective view of a planer in the present invention:

FIG. 2 is a rear and perspective view of the planer in the present invention:

FIG. 3 is an exploded perspective view of a wood waste-removing device for a planer in the present invention:

FIG. 4 is a specifically exploded perspective view of the wood waste-removing device of a planer in the present invention:

FIG. 5 is a lower perspective view of the wind exhausting shade of the wood waste-removing device for a planer in the present invention:

FIG. 6 is a partial cross-sectional view of the wood waste-removing device for a planer in the present invention: and

FIG. 7 is a perspective view of a transmitting cable disconnected from a knife shaft in the present invention.

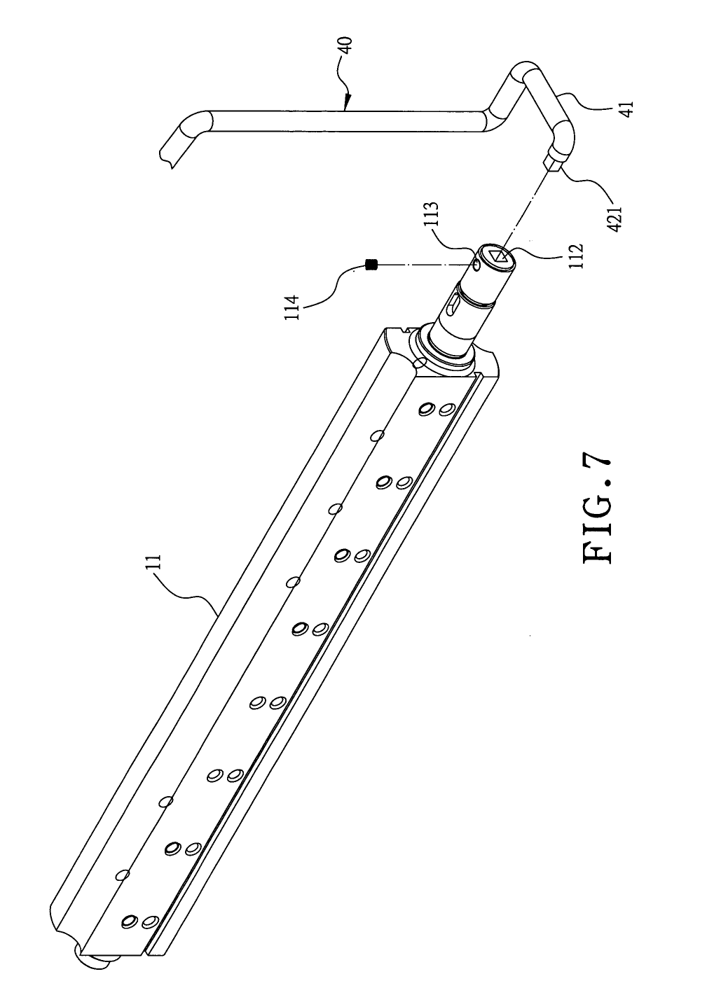

### DETAILED DESCRIPTION OF THE PREFERRED EMBODIMENT

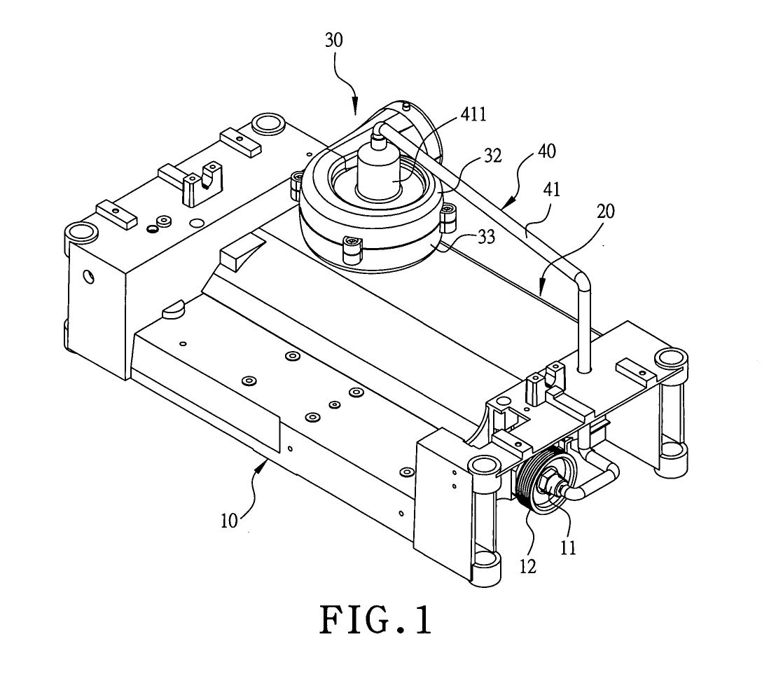

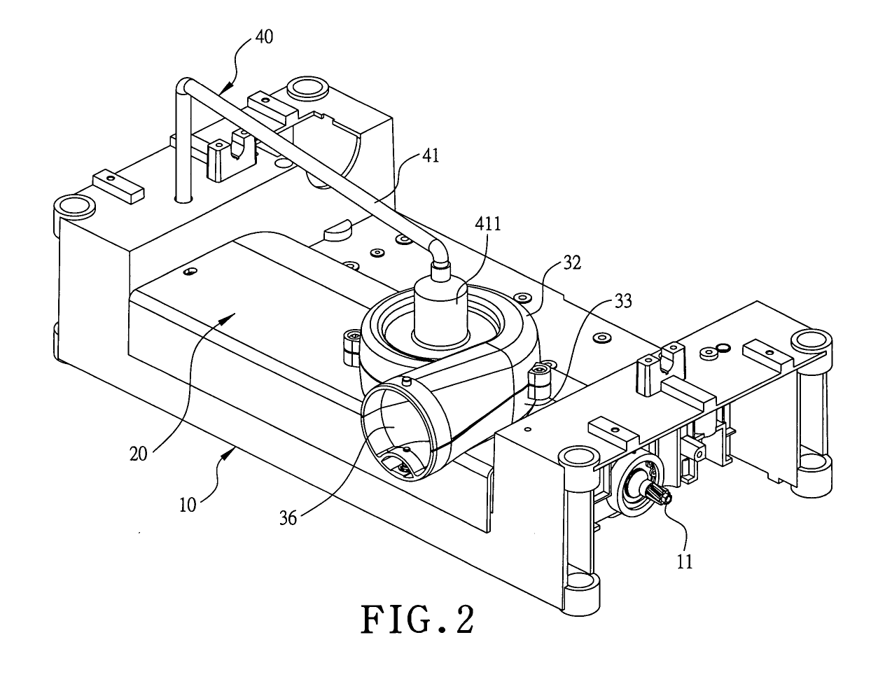

A preferred embodiment of a wood waste-removing device for a planer in the present invention, as shown in FIGS. 1, 2 and 3, includes a planing table 10, a wind exhausting shade 20, a blower 30 and a transmitting cable 40 as main components combined together.

The planing table 10 positioned on a bottom base by four guide columns (not shown) is provided with a knife shaft 11 for fixing a blade 111 thereon. The knife shaft 11 has one end secured thereon with a belt pulley 12 connected with a motor (not shown) by a belt and driven to rotate by the motor. Further, the knife shaft 11 has the end, on which the belt pulley 12 is located, axially bored with a rectangular insert slot 112 having its outer edge laterally bored with a threaded hole 113 communicating with the insert slot 112 and crewed therein with a bolt 114.

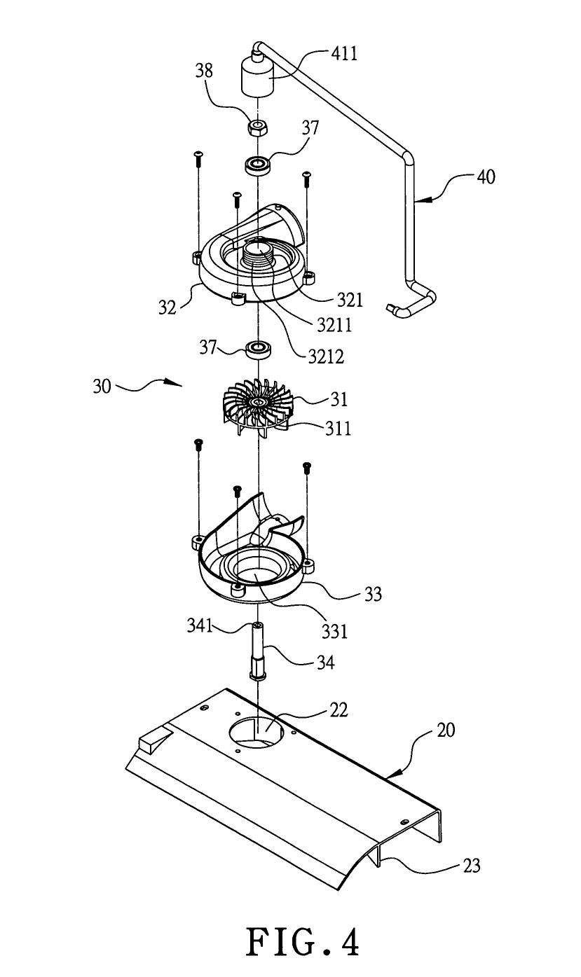

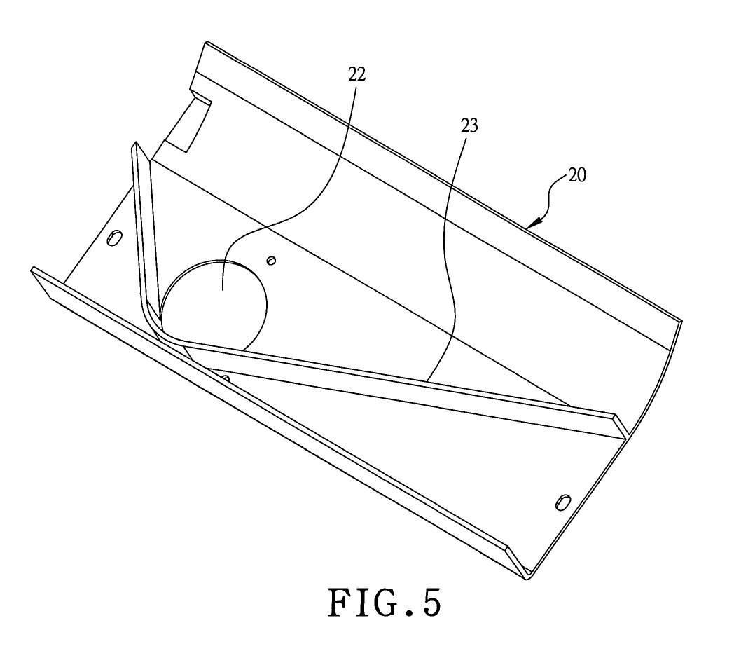

The wind exhausting shade 20, as shown in FIGS. 4 and 5, is assembled above the knife shaft 11 of the planing table 10, having a wind-exhausting chamber 21 formed between the wind exhausting shade 20 and the topside of the planing table 10. The wind removing shade 20 has its topside bored with a vent hole 22 and its inner upper side provided with an elongate and curved wind guiding plate 23 projecting vertically to surround part of the outer edge of the vent hole 22 and having two ends respectively extending obliquely at a preset angle to reach the opposite ends of the wind exhausting shade 20 so that wood waste at the opposite sides of the wind removing shade 20 can be sucked to the vent hole 22 along the wind guiding plate 23.

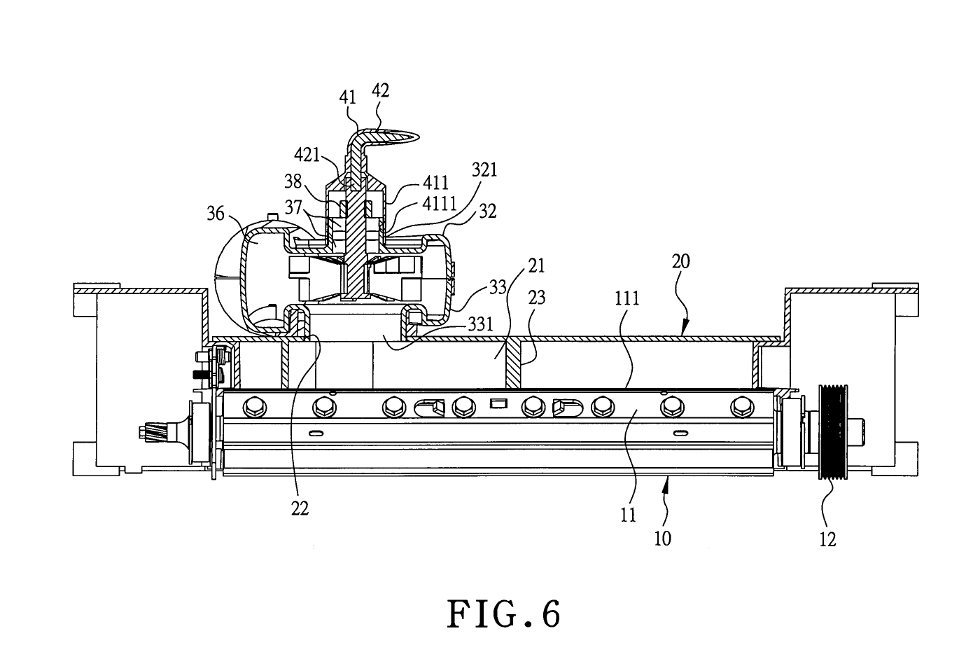

The blower 30, as shown in FIGS. 4 and 6, is composed of a set of wheel-shaped blades 31, an upper and a lower cover 32, 33 and a rotary shaft 34. The two covers 32, 33 are correspondingly combined together to form an accommodating space in the interior and a wind-exhausting vent at one side. The lower cover 33 has its lower side bored with a wind inlet 331, while the upper cover 32 has its topside provided with a shaft tube 321 extending upward, having an insert hole 3211 in the center and having its outer edge formed with outer threads 3212. The lower cover 33 is assembled on the topside of the wind exhausting shade 20 and has its wind inlet 331 aligned to the vent hole 22 of the wind removing shade 20. The wheel-shaped blade 31 is received in the accommodating space 35 of the two shades 32, 33, having an elongate shaft hole 311 in the center. The rotary shaft 34 has a rectangular insert slot 341 bored in the upper end and is upward inserted through the elongate shaft hole 311 of the wheel-shaped blades 31, having two bearings 37 fitted thereon. Then, the rotary shaft 34 is positioned in the insert hole 3211 of the upper cover 32 by means of the two bearings 37, which are locked on the upper end of the rotary shaft 34 by a locking nut 38. Thus, the wheel-shaped blade 31 can be pivotally positioned in the accommodating space 35 of the two covers 32, 33 and driven to rotate by the rotary shaft 34.

The transmitting cable 40 consists of a transmitting tube 41 and a steel cable 42. The transmitting tube 41 is a hollow elongate tube curved in a preset shape and has one end extending downward to form a sleeve 411 with a comparatively large diameter. The sleeve 411 has its inner side formed with inner threads 4111 to be screwed with the shaft tube 321 of the upper cover 32 of the blower 30. The steel cable 42 is received in the transmitting tube 41 and has its opposite ends extending out of the transmitting tube 41 and respectively formed with a rectangular adapter 421. One adapter 421 of the steel cable 42 extends to a location near the outlet of the sleeve 411 of the transmitting tube 41 to be inserted in the insert slot 341 in the top end of the rotary shaft 34, while the other adapter 421 of the steel cable 42 has a little part extending out of the transmitting tube 41 and inserted in the insert slot 112 of the knife shaft 11 and locked therein by the bolt 114 in the threaded hole 113 of the knife shaft 11. Thus, the power of the knife shaft 11 can be transmitted to the rotary shaft 34 of the blower 30 by the steel cable 42 in the transmitting tube 41.

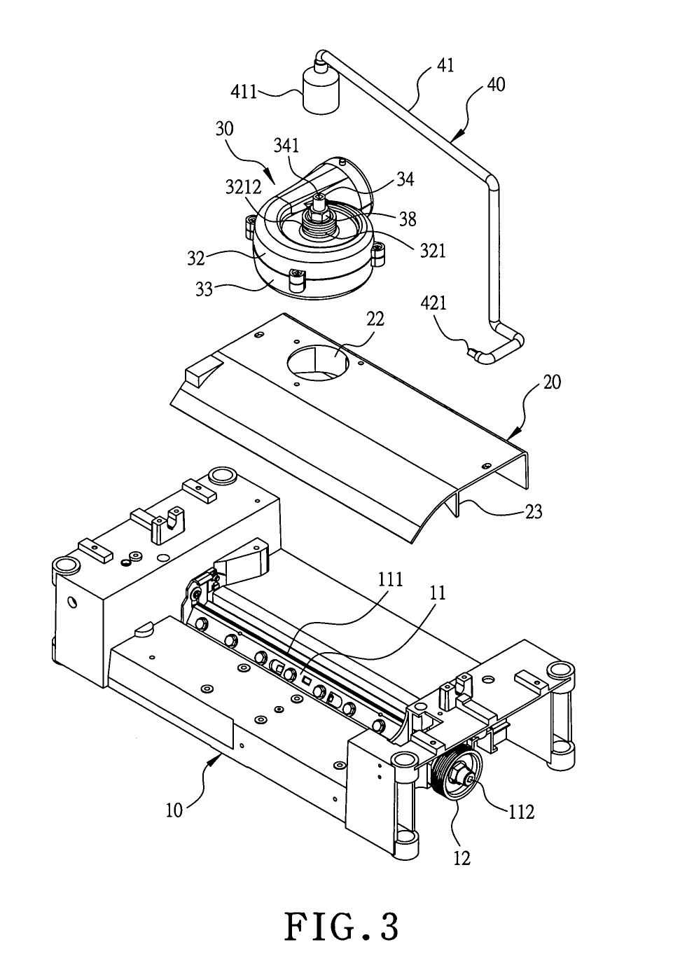

In operating, as shown in FIGS. 3 and 4, when a motor (not shown) drives the belt pulley 12 of the knife shaft 11 to rotate by a belt, the knife shaft 11 will start to rotate and carry out planing and the steel cable 42, which is fixed on one end of the knife shaft 11, will synchronously be actuated to rotate and drive the rotary shaft 34, which is connected with the other end of the steel cable 42, to rotate together with the blade 31 of the blower 30.

Referring to FIG. 6, the set of the blades 31 of the blower 30 is positioned in the accommodating space 35 formed by the upper and the lower cover 32, 33; therefore when the blade 31 rotates, there will produce a vacuum sucking force around the wind inlet 331 of the lower cover 33 to suck the wood waste produced during planing into the accommodating space 35 of the blower 30 through the vent hole 22 of the wind exhausting shade 20 and the wind inlet 331 of the lower cover 33. As the wind exhausting shade 20 assembled under the lower cover 33 is provided with the curved wind guiding plate 23 on the inner upper side, therefore wood waste produced at the opposite sides of the knife shaft 11 can also be sucked in the vent hole 22 of the wind exhausting shade 20 and the wind inlet 331 of the lower cover 33 along the wind guide plate 23. Subsequently, the wood waste sucked in the accommodating space 35 of the blower 30 through the wind inlet 331 of the lower cover 33 is removed out through the wind-exhausting vent 36 at one side of the two covers 32, 33 and through a wind-exhausting pipe (not shown) to be collected.

Evidently, the blower 30 of the wood dust removing device in the present invention is directly driven to operate by the knife shaft 11 through the transmitting cable 40, and the knife shaft 11 is driven to rotate by a motor; therefore the blower 30 and the knife shaft 11 can be synchronously started to operate or stop. In other words, when the knife shaft 11 is started to carry out planing, the blower 30 will be actuated to remove wood waste at the same time, and when the knife shaft 11 stop planing, the blower 30 will automatically stop functioning, convenient in use. Besides, the blower 30 and the knife shaft 11 are driven to operate by the same motor, thus simplifying the structure of the planing table 10, saving cost needed in installing an additional motor and conforming to economic gain.

While the preferred embodiment of the invention has been described above, it will be recognized and understood that various modifications may be made therein and the appended claims are intended to cover all such modifications that may fall within the spirit and scope of the invention.

1. A wood waste removing device for a planer comprising a planing table provided thereon with a knife shaft, said knife shaft having one end fixed with a belt pulley, said belt pulley driven to rotate by a motor: and characterized by,
A blower installed above said knife shaft of said planing table;
A transmitting cable having its opposite ends respectively connected with said blower and one end of said knife shaft, said blower actuated to operate by said knife shaft through said transmitting cable, said blower and said knife shaft driven to operate by the same said motor:

2. The wood waste removing device for a planer as claimed in claim 1, wherein a wind exhausting shade is assembled above said knife shaft of said planing table, with a wind exhausting chamber formed between said wind exhausting shade and the topside of said planing table, said wind exhausting shade having its topside bored with a vent hole at a preset location.

3. The wood waste removing device for a planer as claimed in claim 1, wherein said wind exhausting shade has its inner upper side provided with a curved wind guiding plate projecting vertically to surround part of the outer edge of said vent hole, said wind guiding plate having its opposite ends obliquely extending at a preset angle to the opposite sides of said wind exhausting shade so that wood dust at the opposite sides of said wind exhausting shade can be sucked to said vent hole along said wind guiding plate.

4. The wood waste removing device for a planer as claimed in claim 1, wherein said blower comprises a wheel-shaped blade, an upper and a lower cover and a rotary shaft, said upper and said lower cover correspondingly combined together to form an accommodating space in the interior and a wind exhausting vent at one side, said lower cover bored with a wind inlet at the bottom, said upper cover provided with a shaft tube extending upward from its topside and having outer threads around the outer edge, said wheel-shaped blade received in said accommodating space of said two covers and bored with a central shaft hole, said rotary shaft having its upper end bored with an insert slot, said rotary shaft inserted through said shaft hole of said set of the wheel-shaped blades and fixed therein, said rotary shaft pivotally positioned in said insert hole of said upper cover by means of at least one bearing, said blade able to be positioned in said accommodating space of said two covers and actuated to rotate by said rotary shaft.

5. The wood waste removing device for a planer as claimed in claim 3 or 4, wherein said lower cover of said blower is fixed on the topside of said wind exhausting shade, said wind inlet of said lower cover aligned to said vent hole of said wind exhausting shade.

6. The wood waste removing device for a planer as claimed in claim 1, wherein said knife shaft has one end, on which said belt pulley is fixed, provided with an axially insert slot having its outer edge bored with a threaded hole, said threaded hole communicating with said insert slot and screwed therein with a bolt.

7. The wood waste removing device for a planer as claimed in claim 1, 4 or 6, wherein said transmitting cable comprises a transmitting tube and a steel cable, said transmitting tube being a hollow elongate tube curved in a preset shape, said transmitting tube having one end extending downward to form a sleeve with a comparatively large diameter, said sleeve having its inner wall formed with female threads, said steel cable received in said transmitting tube and having its opposite ends respectively formed with a non-round adapter, one said adapter of said steel cable extending to a location near the outlet of said sleeve of said transmitting tube, said other adapter of said steel cable having a preset part extending out of the other end of said transmitting tube, said sleeve of said transmitting tube screwed with said shaft tube of said upper shade of said blower, said adapter of said steel cable inside said sleeve of said transmitting tube inserted and positioned in said insert slot of said rotary shaft, said other adapter of said steel cable inserted in said insert slot at one end of said knife shaft and fixed therein by a bolt, said knife shaft driven to rotate by said motor and transmit power to said rotary shaft of said blower by means of said steel cable inside said transmitting tube.
